(19) United States
(12) Patent Application Publication
(10) Pub. No.: US 2014/0250746 A1
(43) Pub. Date: Sep. 11, 2014

(54) Signalling device for structural reinforcements

(71) Applicant: Luis Adell Lopez, Madrid (ES)

(72) Inventor: Luis Adell Lopez, Madrid (ES)

(21) Appl. No.: 14/237,119

(22) PCT Filed: Aug. 5, 2011
(86) PCT No.: PCT/ES2011/070581

§ 371 Date: May 30, 2014

(51) Int. Cl. G09F 3/20

(52) U.S. Cl. CPC G09F 3/20
USPC 40/299.01

(57) ABSTRACT

A signaling device for structural reinforcements in the form of bars or plates, with the signaling device comprising at least one identification label and additionally a part which can be connected to the bars or plates of the reinforcement in such a way that at least one identification label projects from the connectable part. The label has two differentiated zones: an inner zone adjacent to the connectable part and another outer zone, located further from said part. The inner zone of the identification label may comprise a color mark with a length equal to the length of the side mortar coating required when the reinforcement is embedded in the bed joint of a wall.

### CROSS-REFERENCES TO RELATED APPLICATIONS

This application claims the benefit of the International Application PCT/ES2011/070581 filed Aug. 5, 2011, designating the United States and published on Feb. 14, 2013 as WO 2013/021072, the entire disclosures of which are incorporated herein by way of reference.

### BACKGROUND OF THE INVENTION

This invention concerns a signaling device for structural reinforcements. The signaling device is used in this type of reinforcement, specifically in those which are embedded in prefabricated wall joints, with a structural function related to the mechanical performance of the wall in which they are used.

Prefabricated reinforcements that are used for embedding in masonry wall bed joints (also known as “bed joint reinforcements”) and which are intended to improve the mechanical performance of walls, consist of two longitudinal steel bars or plates connected at given distances by other transverse bars or plates, or by a continuous plate forming a triangular lattice.

Bed joint reinforcements currently on the market have various geometric configurations. Thus, for example, the applicant's GEOFOR® standard bed joint reinforcement belongs to the triangular lattice group.

These reinforcements are embedded in the prefabricated masonry wall joints, so that when they are installed they are no longer visible, which makes it difficult to ascertain whether or not the wall is reinforced.

Furthermore, when using these internal reinforcements, at times, the side mortar coating may not be sufficient, as required, with the result that considerable and inconvenient maneuvering and handling is necessary on site.

The requirement of covering with mortar the whole perimeter of the bars throughout the length of the part is fundamental in order to ensure appropriate conditions for protecting the reinforcement against corrosion which could be caused by a humidity bridge.

### SUMMARY OF THE INVENTION

The purpose of this invention is to provide a signaling device for structural reinforcements of the type embedded in bed joints of prefabricated walls, and which is able to overcome the difficulties of the previous technique, while at the same time complying with the following:
Ensure adequate coating with mortar throughout the perimeter and length of the parts, facilitating installation on site.
Enable inspection and checks of the reinforcement on site once the wall has been erected, and where the reinforcements are not visible to the naked eye.
Facilitate traceability of the product.

The invention provides a signaling device for structural reinforcements consisting of bars or plates, with the signaling device comprising at least one identification label and additionally a part which connects to the bars or plates of the reinforcement in such a way that the identification label projects from the connectable part, and said label has two differentiated zones, namely an inner zone adjacent to the connectable part and another outer zone which is distanced further from said part, with the inner zone comprising a color mark.

The configuration of the signaling device with a connectable part which can be connected to the bars or plates comprising the reinforcement, and an identification label with two differentiated zones permits the correct fitting of the reinforcement within the plane of the bed joint, in order to check that there is sufficient side mortar coating. The identification function is achieved by indicating the corresponding information (for example type of product, origin and manufacturing batch) on the outer zone of the label.

### BRIEF DESCRIPTION OF THE DRAWINGS

The subject of this invention will be illustrated below in a non-restrictive manner, by making reference to the accompanying drawings, in which:

FIG. 1 shows a plan view of a section of reinforcement provided with two signaling devices in accordance with the invention.

FIG. 2 shows a detailed view of FIG. 1, in the area in which one of the signaling devices is located.

FIG. 3 shows another view of the reinforcement with signaling device placed on it.

FIG. 4 shows a perspective view of the reinforcement with a signaling device placed on it.

FIG. 5 shows a plan view of two overlapping bed joint reinforcements.

FIG. 6 shows a plan view of a bed joint reinforcement on masonry parts which show the side mortar coating.

### DETAILED DESCRIPTION OF THE PREFERRED EMBODIMENTS

FIG. 1 shows a standard bed joint reinforcement 2 in the form of a triangular lattice with two signaling devices 1 in accordance with the invention.

The signaling devices 1 may be fitted in any position on the outer or diagonal wires, provided that they are distanced uniformly. The devices fitted at the ends of the reinforcements 2 should be situated at a distance such that they will coincide when the overlap length of the bars 3 is adequate, in those configurations in which there is overlap at the ends of adjacent reinforcements 2.

FIG. 1 shows a diagram of a proposal for locating and separating the devices described, although these proposals are not restrictive in any way and any other option which permits the function described would be viable.

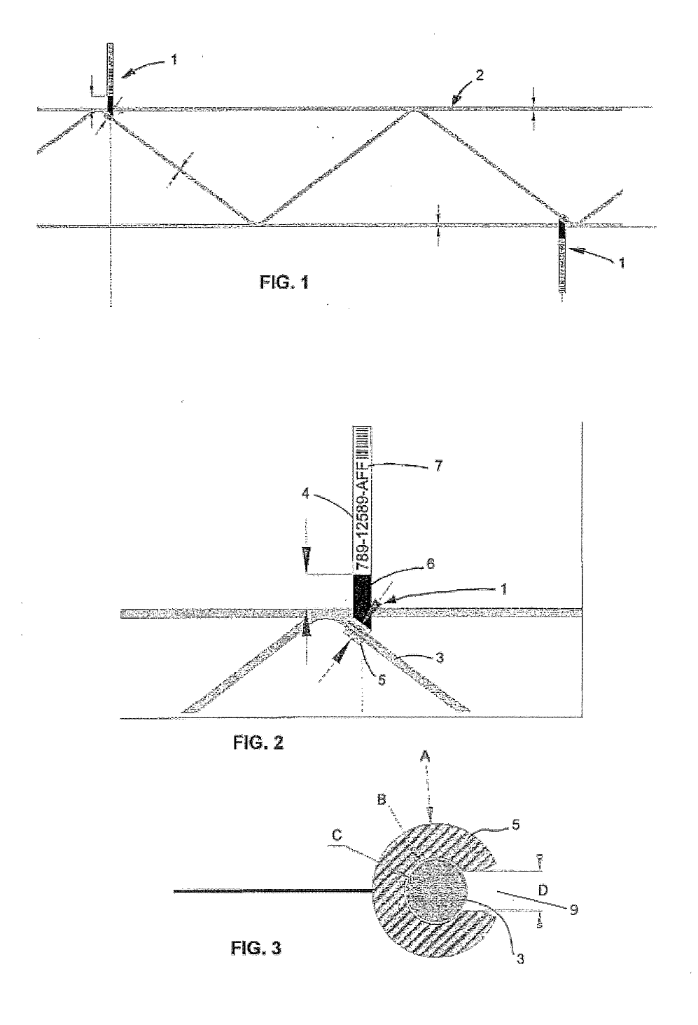

FIG. 2 shows a detailed view of FIG. 1 in the zone where one of the signaling devices 1 is located. 1.

The signaling device 1 comprises at least one identification label 4 (in the embodiment of FIG. 2 only one label 4), and a part 5 which can be connected to the bars or plates of the reinforcement 2. The identification label 4 projects from said connectable part 5 and has two differentiated zones: an inner zone 6, adjacent to the connectable part 5, and another outer zone 7, at a further distance from said part 5.

The identification labels 4 may have a color coded mark and contain figures for the purpose of product traceability.

With a simple visual inspection it is possible to check the presence of the reinforcement 2. The label 4 count enables the amount of reinforcement 2 in place and its distribution to be ascertained. The color mark enables correct fitting within the bed joint plane to be checked, in order to ensure that there is sufficient side coating. The label code 4 can indicate the type of product, its origin and the manufacturing batch. These aspects are clearly indicated in FIG. 2.

In the embodiment of FIG. 2, the label color mark 4 has a length equal to the side coating required (see also FIG. 6). If the color remains visible once the wall has been erected, this is an indication that the side coating is insufficient. Furthermore, the labels 4 fitted at the ends of the reinforcements 2 should coincide in position; if there is a discrepancy between them, this is an indication that the length of the coating is insufficient.

The label 4 may project from the lateral surface of the connectable part 5 forming an angle of less than 90° with respect to said part, which is useful when connecting diagonal bars or plates (see FIGS. 1 and 2).

FIG. 3 shows that the connectable part 5 may comprise a hollow cylindrical body with a lateral groove 9 along its height.

The connectable part 5 may be in the form of a hollow cylindrical wedge, with a groove 9 which enables it to be prefabricated using pressure. The inner diameter of the separator is in accordance with the diameter of the wires in the reinforcement 2. The thickness of the part 5 has a value corresponding to the minimum coating of the upper and lower edges of the reinforcement 2. FIG. 3 shows an example of the geometry and dimensions of the connectable part 5 which is connected to the reinforcement 2 fitted in its interior. In this particular embodiment the dimensions marked would be as follows:

A (outer diameter of connectable part 5): 8.0 mm

B (inner diameter of connectable part 5): 4.0 mm

C (outer diameter of the bar or rod 3): 3.7 mm

D (width of the groove 9 aperture): 2.4 mm

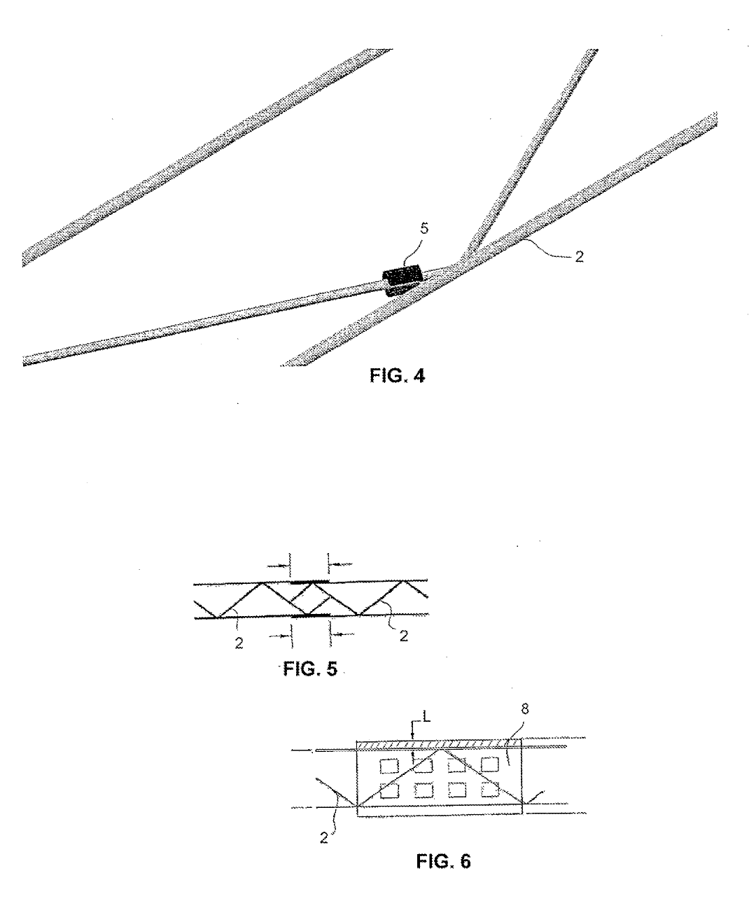

FIG. 4 shows a detail in perspective of the reinforcement 2 with the connectable part 5 connected.

The material of the body of the connectable parts 5 may be of any type that complies with two essential requirements:
It should be physically and chemically inert in order to be permanently embedded in the wall interior, in contact with both the mortar and with the masonry parts 8 and the reinforcements 2.
It should be waterproof in order to disrupt the humidity bridges between the masonry parts 8 and the incorporated reinforcement 2, thus preventing the risk of corrosion in the latter.

The body of the identification labels shall be made from any material that complies with two essential requirements:
It should remain intact for a reasonable period of time in that it is able to withstand aggressive weather conditions, and yet at the same time it should be removable when the wall is cleaned.
It should be made from biodegradable material which does not leave any hazardous residue when removed.

It is proposed that suitable materials for these two components would be rigid plastic (in the case of the connectable parts 5) and biodegradable paper with a high or medium weight In the case of the labels 4).

FIG. 5 shows a plan view of two overlapped bed joint reinforcements 2, together with their overlap lengths. In these figures the overlapping is installed along the same plane, with the end of one part connected to the end of the contiguous part.

FIG. 6 shows a plan view of a reinforcement 2 on masonry parts 8 which show the side mortar coating L.

Although some embodiments of the invention have been described and represented, it is clear that modifications comprised in its scope can be introduced and that it must not be considered to be limited to these embodiments, but solely to the contents of the following claims.

As is apparent from the foregoing specification, the invention is susceptible of being embodied with various alterations and modifications which may differ particularly from those that have been described in the preceding specification and description. It should be understood that I wish to embody within the scope of the patent warranted hereon all such modifications as reasonably and properly come within the scope of my contribution to the art.

1-7. (canceled)

8. A signaling device for structural reinforcements formed by bars or plates with said signaling device comprising:
at least one identification label,
the label having a connectable part which can be connected to the bars or plates of the reinforcement in such a way that the at least one identification label projects from the connectable part, and
the label having two differentiated zones: an inner zone adjacent to the connectable part and an outer zone located further from said connectable part,
the inner zone of the identification label comprising a color mark.

9. The signaling device for structural reinforcements according to claim 8, wherein the color mark of the label has a length equal to a length of a side mortar coating required when the structural reinforcement is embedded in a bed joint of a wall.

10. The signaling device for structural reinforcements according to claim 8, wherein the connectable part comprises a hollow cylindrical body with a side groove along its whole height.

11. The signaling device for structural reinforcements according to claim 8, wherein the label projects from a side surface of the connectable part forming an angle of less than 90° with respect to the connectable part.

12. The signaling device for structural reinforcements according to claim 8, wherein the connectable part is made from a rigid plastic.

13. The signaling device for structural reinforcements according to claim 8, wherein the label is made from one of a high and medium weight paper.
